(19) United States
(12) Patent Application Publication
(10) Pub. No.: US 2019/0028006 A1
(43) Pub. Date: Jan. 24, 2019

(54) MANUFACTURING METHOD OF LAMINATED STEEL AND LAMINATED STEEL MANUFACTURING APPARATUS

(71) Applicants: HONDA MOTOR CO., LTD., Tokyo (JP); Kuroda Precision Industries Ltd., Kawasaki-shi (JP)

(72) Inventors: Go Hamamura, Wako-shi (JP); Manabu Sakurada, Wako-shi (JP); Kenta Ninomiya, Wako-shi (JP); Koichi Nishinaka, Kawasaki-shi (JP)

(73) Assignees: HONDA MOTOR CO., LTD., Tokyo (JP); Kuroda Precision Industries Ltd., Kawasaki-shi (JP)

(21) Appl. No.: 16/033,346

(22) Filed: Jul. 12, 2018

(30) Foreign Application Priority Data
Jul. 18, 2017 (JP) 2017-139281

(51) Int. Cl. H02K 15/02; H02K 15/03

(52) U.S. Cl. CPC H02K 15/028; H02K 1/18; H02K 15/03

(57) ABSTRACT

Provided is a method of manufacturing laminated steel plates by laminating a plurality of steel plates, the method including an application process of applying an adhesive agent on a surface of each of the steel plates, and a lamination process of laminating a steel plate, to which the adhesive agent is applied, and another steel plate while shifting positions of the steel plates about an axis with each other, and causing the steel plate to adhere to a laminated body using the adhesive agent, wherein, in the application process, the adhesive agent is applied such that the adhesive agent becomes in a shape that is continuous about a central axis when the steel plate and the other steel plate are adhered by the adhesive agent in the lamination process.

### CROSS-REFERENCE TO RELATED APPLICATION

Priority is claimed on Japanese Patent Application No. 2017-139281, filed Jul. 18, 2017, the content of which is incorporated herein by reference.

### BACKGROUND OF THE INVENTION

### Field of the Invention

The present invention relates to a method and an apparatus for manufacturing laminated steel plates.

### Description of Related Art

An electric motor used in a hybrid automobile or the like includes, for example, a rotor, and a stator configured to generate a rotating magnetic field. A stator core of the stator is constituted by laminated steel plates obtained by laminating steel plates. The plurality of steel plates that constitute the laminated steel plates are fixed to each other through formation of a caulking section, adhesion by an adhesive agent, or the like (see Japanese Unexamined Patent Application, First Publication No. 2007-159300 and Japanese Unexamined Patent Application, First Publication No. 2009-5539).

For example, the stator core is fabricated as follows. An annular steel plate is fabricated through punching or the like, and a plurality (for example, several tens to several hundreds) of steel plates are laminated. In order to uniformize a lamination thickness of the steel plates in a circumferential direction, or the like, the steel plates are laminated by shifting the positions in the circumferential direction for every predetermined number of sheets.

When the fixing by the caulking section is employed, the caulking section is formed on the laminated steel plates through pressing. When the fixing by the adhesive agent is employed, steel plates on which adhesive agent layers have been previously formed are laminated.

### SUMMARY OF THE INVENTION

However, in the above-mentioned manufacturing method, when the fixing by the caulking section is employed, a loss due to conduction between the steel plates in the caulking section may occur.

In addition, when the fixing by the adhesive agent is employed, the adhesive agent layers need to be previously formed on the steel plates. In addition, after the steel plates are fabricated through punching or the like, processes of extracting the steel plates from a manufacturing apparatus, laminating the steel plates manually and hardening the adhesive agent through heating are needed. For this reason, there is a problem that the productivity is decreased.

An aspect of the present invention is directed to providing a method and an apparatus for manufacturing laminated steel plates, in which conduction does not occur between the steel plates and the productivity is not decreased.

(1) A method of manufacturing laminated steel plates according to an aspect of the present invention is a method of manufacturing laminated steel plates by laminating a plurality of steel plates, the method including: an application process of applying an adhesive agent on a surface of each of the steel plates; and a lamination process of laminating a steel plate, on which the adhesive agent is applied, and another steel plate while shifting positions of the steel plates about an axis, which extends in a thickness direction of the steel plate, with each other, and causing the steel plate, to which the adhesive agent is applied, to adhere to the other steel plate by using the adhesive agent, wherein, in the application process, the adhesive agent is applied such that the adhesive agent becomes in a shape that is continuous about the axis when the steel plate and the other steel plate are adhered by the adhesive agent in the lamination process.

(2) In the above mentioned aspect of (1), in the application process, the adhesive agent may be applied on the surface of the steel plate in a plurality of spot shapes.

(3) In the above mentioned aspect of (1) or (2), all the steel plates on which the adhesive agent is applied in the application process may be supplied to the lamination process.

(4) In the above mentioned aspect of any one of (1) to (3), the application process and the lamination process may be performed in a common manufacturing apparatus.

(5) An apparatus for manufacturing laminated steel plates according to an aspect of the present invention is an apparatus for manufacturing laminated steel plates by laminating a plurality of steel plates, the apparatus including: a supply part that applies an adhesive agent on a surface of each of the steel plates; and a lamination part that laminates a steel plate, on which the adhesive agent is applied, and another steel plate while shifting positions of the steel plates about an axis, which extends in a thickness direction of the steel plate, with each other, and that causes the steel plate, to which the adhesive agent is applied, to adhere to the other steel plate by using the adhesive agent, wherein the supply part applies the adhesive agent such that the adhesive agent becomes in a shape that is continuous about the axis when the steel plate and the other steel plate are adhered by the adhesive agent by the lamination part.

According to the above mentioned aspect of (1), in the application process, when a steel plate and another steel plate are adhered by the adhesive agent in the lamination process, since the adhesive agent is applied such that the adhesive agent becomes in a shape that is continuous about the axis, the adhesive agent is applied to a wide range about the axis. For this reason, a stress concentration does not easily occur even when a shearing force is applied to the adhesive agent layer in the hardening process, and inhibition of a hardening reaction due to the shearing stress does not easily occur. Accordingly, since an adhesive strength of the adhesive agent layer can be increased, an amount of the adhesive agent used can be minimized. Accordingly, a time required for hardening can be reduced, a speed of production can be increased, and minimization of manufacturing costs can be achieved.

According to the above mentioned aspect of (1), since the steel plates are adhered and fixed via the adhesive agent layer, an increase in loss can be avoided without causing conduction between the steel plates. Further, since a process is simplified, a decrease in productivity does not occur.

According to the above mentioned aspect of (2), since the adhesive agent is applied on the surface of the steel plate in a plurality of spot shapes, when the steel plate and the other steel plate are overlapped with each other in the lamination process, the adhesive agent applied in the spot shapes spread out and are securely applied on the surface of the steel plate in an annular shape. Accordingly, since the adhesive agent is applied in a wide range about the axis, the above-mentioned stress concentration does not easily occur.

According to the above mentioned aspect of (3), since all the steel plates on which the adhesive agent is applied in the application process are supplied to the lamination process, a deviation of the lamination thickness in the circumferential direction of the steel plates in the laminated steel plates does not easily occur. In addition, a flatness of the laminated steel plates becomes good. Accordingly, dimensional accuracy of the laminated steel plates can be improved.

According to the above mentioned aspect of (4), since the application process and the lamination process are performed in a common manufacturing apparatus, productivity can be increased in comparison with a manufacturing method in which an operation of extracting the steel plates from the manufacturing apparatus and a process of laminating the steel plates is needed.

According to the above mentioned aspect of (5), since the supply part that applies the adhesive agent such that the adhesive agent becomes in a shape that is continuous about the axis when a steel plate and another steel plate are adhered to each other by the adhesive agent by the lamination part, the adhesive agent is applied to a wide range about the axis. For this reason, since a stress concentration does not easily occur even when a shearing force is applied to the adhesive agent layer in the hardening process, inhibition of a hardening reaction due to the shearing stress does not easily occur.

Accordingly, an adhesive strength of the adhesive agent layer can be increased, and an amount of the adhesive agent used can be minimized. Accordingly, a time required for hardening can be reduced, a speed of production can be increased, and minimization of manufacturing costs can be achieved.

According to the above mentioned aspect of (5), since the steel plates are adhered and fixed via the adhesive agent layer, an increase in loss can be avoided without conduction occurring between the steel plates. Further, since a process is simplified, a decrease in productivity does not occur.

### BRIEF DESCRIPTION OF THE DRAWINGS

FIG. 1 is a view for explaining a method of manufacturing laminated steel plates of an embodiment.

FIG. 2A is a perspective view showing a state in which an adhesive agent is applied in an application process before steel plates are laminated in a lamination process.

FIG. 2B is a perspective view showing a steel plate on which an adhesive agent layer is formed after the steel plates are laminated in the lamination process.

FIG. 3A is a view for explaining the method of manufacturing the laminated steel plates of the embodiment.

FIG. 3B is a view for explaining the method of manufacturing the laminated steel plates of the embodiment.

FIG. 3C is a view for explaining the method of manufacturing the laminated steel plates of the embodiment.

FIG. 3D is a view for explaining the method of manufacturing the laminated steel plates of the embodiment.

FIG. 4 is a perspective view showing a stator core that is an example of the laminated steel plates obtained by the manufacturing method of the embodiment.

FIG. 5A is a perspective view showing a structure of a laminated body obtained by a manufacturing method of Example 1.

FIG. 5B is a perspective view schematically showing an adhesive agent layer in Example 1.

FIG. 6A is a perspective view showing a structure of a laminated body obtained by a manufacturing method of Comparative example 1.

FIG. 6B is a perspective view schematically showing an adhesive agent layer in Comparative example 1.

FIG. 7 is a view showing a test result.

### DETAILED DESCRIPTION OF THE INVENTION

Hereinafter, an embodiment of the present invention will be described with reference to the accompanying drawings.

### [Laminated Steel Plate]

First, an example of an electric motor to which laminated steel plates obtained by a manufacturing method of the embodiment can be applied will be described.

The electric motor includes, for example, a rotor, and a stator configured to generate a rotating magnetic field. A stator core of the stator is formed in a cylindrical shape. The stator core is fixed to a housing by fixing tools in a state in which a coil is wound therearound. The stator core is constituted by laminated steel plates obtained by laminating a plurality of steel plates in order to reduce an induced current or the like.

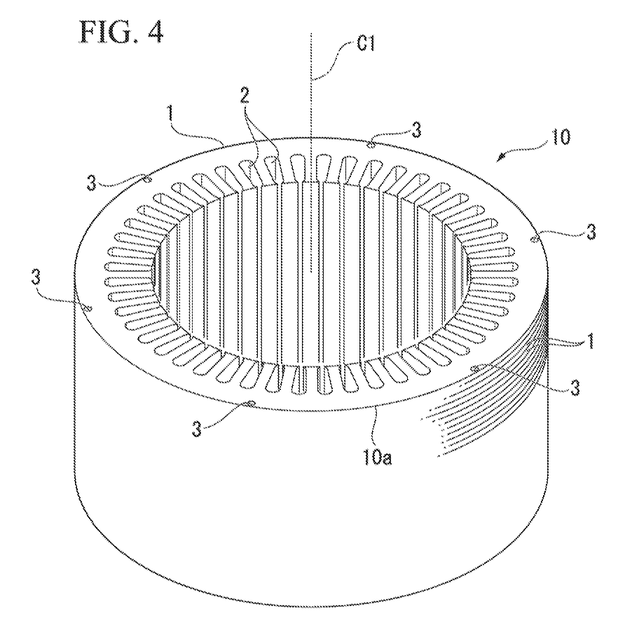

FIG. 4 is a perspective view showing an example of the stator core. A stator core 10 is constituted by laminated steel plates obtained by laminating a plurality of annular plates 1 (steel plates) having the same shape. The stator core 10 has a plurality of coil slots 2, and a plurality of insertion holes 3 through which the above-mentioned fixing tools (bolts or the like) are inserted. The number of the annular plates 1 that constitute the stator core 10 is, for example, 300.

Each of the annular plates 1 is formed of a steel plate (for example, an electro-magnetic steel plate). The annular plate 1 is formed in a substantially annular shape. An external form of the annular plate 1 is, for example, a circular shape when seen in a plan view.

The insertion holes 3 are formed at positions close to an outer circumferential edge 10a of the stator core 10. A plurality of insertion holes 3 are formed at rotation-symmetrical positions with, for example, n-fold symmetry (n is an integer of 2 or more) with respect to a central axis C1 of the stator core 10. The insertion holes 3 may be formed at rotation-symmetrical positions of, for example, 6-fold symmetry. The central axis C1 extends in a thickness direction of the annular plates 1.

### [Apparatus for Manufacturing Laminated Steel Plate]

Next, a method of manufacturing laminated steel plates of the embodiment will be described using the case in which the stator core 10 (the laminated steel plates) are manufactured as an example.

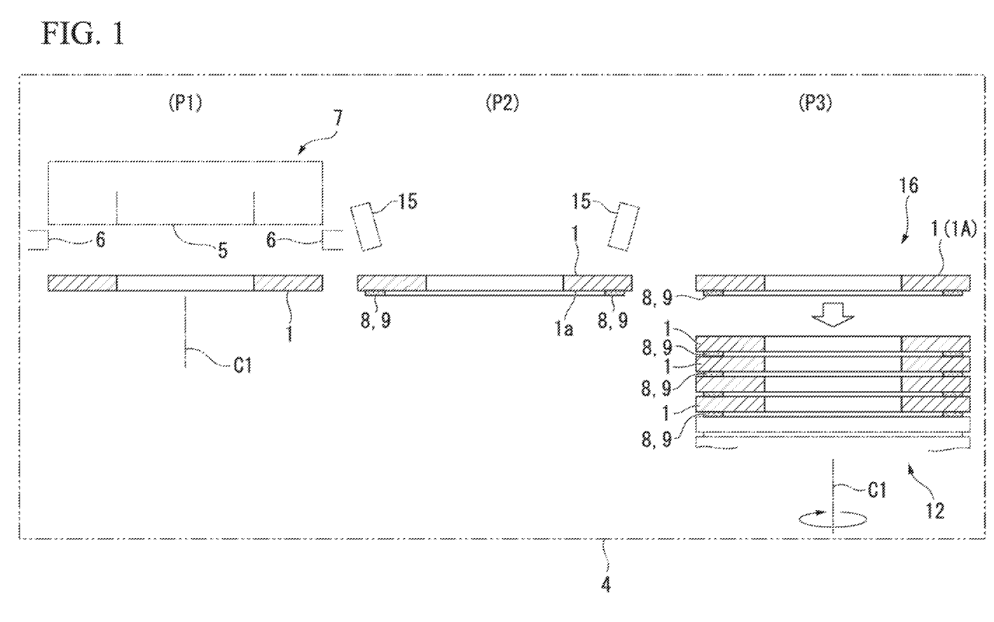

In the manufacturing method, the stator core 10 is fabricated by first process P1, second process P2 and third process P3 using an apparatus 4 for manufacturing laminated steel plates shown in FIG. 1.

The manufacturing apparatus 4 includes a punching mold 7 (a punching means) configured to punch the annular plates 1, a supply part 15 (an applying means) such as a nozzle or the like configured to apply an adhesive agent 8 to a surface 1a of the annular plates 1, and a lamination part 16 (a laminating means) configured to laminate the annular plates 1 on a laminated body 12 while shifting the positions of the laminated body 12 in a circumferential direction.

The punching mold 7 has an upper mold 5 (a punch) and a lower mold 6 (a die).

### [Method of Manufacturing Laminated Steel Plates]

Hereinafter, processes will be described in detail.

### (First Process P1, Punching Process)

A steel plate member (not shown) formed of an electro-magnetic steel plate or the like is prepared. Press oil for the following pressing may be applied on one surface of the steel plate member. In addition, in order to increase an adhesive strength of the adhesive agent layer to be described below, a primer may be applied on this surface of the steel plate member.

As shown in FIG. 1, the steel plate member is introduced into the manufacturing apparatus 4, the steel plate member is punched using the punching mold 7, and thus, the annular plate 1 is obtained. The annular plate 1 is formed in an annular shape about the central axis C1. Further, the circumferential direction is a direction about the central axis C1.

### (Second Process P2, Application Process)

An adhesive agent layer 9 is formed by applying the adhesive agent 8 on the surface 1a of the annular plate 1 using the supply part 15. The surface 1a is preferably a surface opposite to the surface on which the above-mentioned press oil and primer are applied.

An anaerobic adhesive agent, a thermosetting adhesive agent, a two-component reactive curable adhesive agent, or the like, may be used as the adhesive agent 8. In particular, the anaerobic adhesive agent is preferable because a high adhesive strength is obtained. An agent having normal temperature hardenability may be used as the anaerobic adhesive agent. The adhesive agent 8 is preferably an insulating material.

An anaerobic adhesive agent is an adhesive agent that hardens as polymerization proceeds when the air is shut off in the presence of metal ions, and for example, an acrylic adhesive agent (for example, including dimethacrylates such as hydroxyalkyl methacrylate, urethane methacrylate, and so on, epoxy acrylate, or the like) may be used.

An application quantity of the adhesive agent 8 that constitutes the adhesive agent layer 9 may be, for example, 0.1 g/m² or more and 20 g/m² or less.

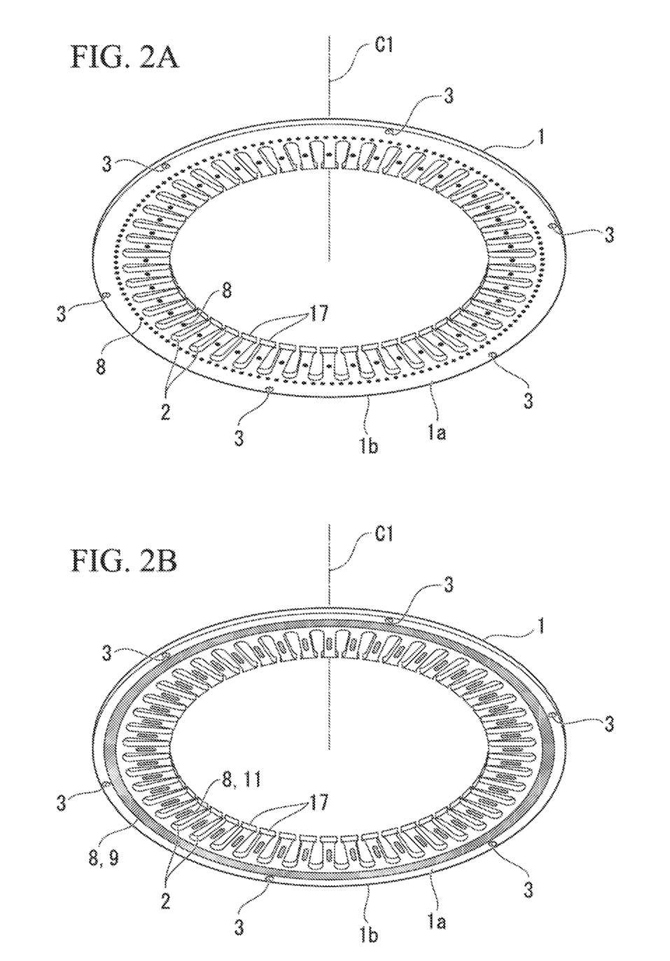

FIG. 2A is a perspective view showing a state in which an adhesive agent is applied through an application process before steel plates are laminated through a lamination process.

FIG. 2B is a perspective view showing a steel plate on which an adhesive agent layer is formed after the steel plates are laminated through the lamination process.

As shown in FIG. 2A and FIG. 2B, the adhesive agent 8 is applied such that the adhesive agent 8 (the adhesive agent layer 9) is formed in a shape that is continuous in the circumferential direction about the central axis when the annular plates 1 and the laminated body 12 are adhered to each other in the third process P3.

Specifically, as shown in FIG. 2A, the adhesive agent 8 is applied on the surface 1a of the annular plate 1 in a plurality of spot shapes in the circumferential direction about the central axis C1. The adhesive agent 8 is applied, for example, at two places where corresponding to the teeth 17 and one place between the neighboring teethes 17 in spot shapes at equal intervals with each other. A diameter of the adhesive agent 8 applied in the spot shape is set to, for example, about ⅓ of a width of the teeth 17.

Accordingly, when the annular plates 1 and the laminated body 12 are superimposed and adhered in the third process P3, the adhesive agent 8 applied in the spot shapes are spread out. Then, the adhesive agent layer 9 becomes to a shape that is continuous in the circumferential direction about the central axis C1. Specifically, as shown in FIG. 2B, when the annular plates 1 and the laminated body 12 overlap each other in the third process P3, the adhesive agent 8 applied in the spot shapes are spread out and the adhesive agent layer 9 becomes in an annular shape. In this way, a stress concentration does not easily occur when the laminated body 12 is rotated in the third process P3 by applying the adhesive agent 8 in the spot shapes in the circumferential direction about the central axis C1 such that the adhesive agent layer 9 becomes in an annular shape.

It is preferable that the adhesive agent Bis applied such that the adhesive agent layer 9 is formed in a shape that is continuous in the circumferential direction about the central axis C1 when the annular plates 1 and the laminated body 12 are adhered in the third process P3. Accordingly, a pitch or a diameter of the adhesive agent 8 applied in the spot shapes is not limited to that in the embodiment, and may be appropriately set such that the adhesive agent layer 9 is formed in a shape that is continuous in the circumferential direction about the central axis C1 in the third process P3 according to a diameter or a width in the radial direction of the annular plate 1, a viscosity of the adhesive agent 8, a thickness of the adhesive agent layer 9, or the like.

The adhesive agent layer 9 may be formed in, for example, a belt shape having a certain width. The adhesive agent layer 9 can be formed at positions close to an outer circumferential edge 1b of the surface 1a while having a constant interval from the outer circumferential edge 1b. The adhesive agent layer 9 is preferably disposed inside the insertion holes 3 in the radial direction.

A thickness of the adhesive agent layer 9 may be, for example, 0.1 μm or more and 20 μm or less.

An adhesive agent layer 11 formed of the adhesive agent 8 may be formed at the teeth 17 on the surface 1a. A shape of the adhesive agent layer 11 when seen in a plan view is, for example, an elliptical shape in the radial direction.

### (Third Process P3, Lamination Process)

As shown in FIG. 1, in the lamination part 16, the annular plate 1 (1A) on which the adhesive agent layer 9 is formed and a laminated body 12 of another annular plate 1 are laminated while being shifted about the central axis C1.

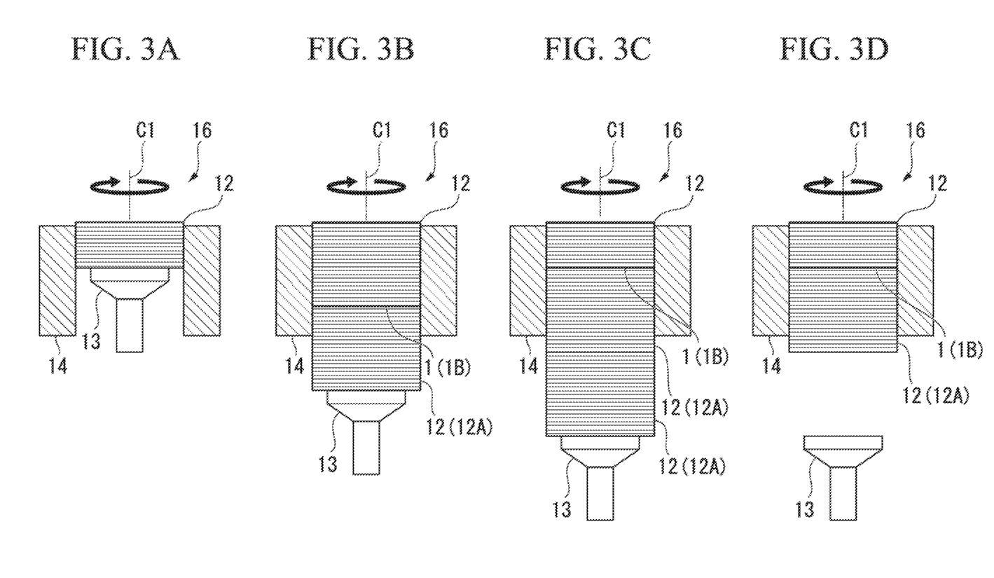

As shown in FIG. 3A, for example, when a position of the laminated body 12 in the circumferential direction is varied by rotating a support section 13, which supports the laminated body 12 from below, about the central axis C1, positions of the annular plates 1 and the laminated body 12 in the circumferential direction can be shifted with each other.

Since the insertion holes 3 (see FIG. 2A and FIG. 2B) of the annular plate 1 are disposed at positions that are rotationally symmetrical with respect to the central axis C1, as shown in FIG. 1, a rotational angle of the laminated body 12 is preferably selected such that positions of the insertion holes 3 correspond to positions of the insertion holes 3 of the annular plate 1 (1A). For example, in the annular plate 1 shown in FIG. 2A and FIG. 2B, since the six insertion holes 3 are disposed uniformly in the circumferential direction, a rotational angle of the laminated body 12 is preferably any one of 60° and its multiples (i.e., 60°, 120°, 180°, 240° and 300°).

In this way, laminating the annular plates 1 while relatively shifting the annular plates 1 about the central axis C1 with respect to the laminated body 12 is referred to as rotating-buildup.

As shown in FIG. 1, all the annular plates 1 passing through the second process P2 are preferably supplied to the third process P3. That is, rather than only one plate among the plurality of plates, it is preferable that positions of the annular plates 1 and the laminated body 12 in the circumferential direction differ from each other for all the annular plates 1 that has passed through the second process P2. Accordingly, a deviation of the lamination thickness in the circumferential direction of the annular plates 1 in the stator core 10 does not easily occur. In addition, flatness of the stator core 10 becomes good. Accordingly, dimensional accuracy of the stator core 10 can be improved.

A press pressure is applied to the laminated annular plate 1 (1A) in the laminated body 12 toward the laminated body 12. Accordingly, the adhesive agent layer 9 of the annular plates 1 (1A) is adhered to the laminated body 12 with no gaps.

As shown in FIG. 3A and FIG. 3B, by repeating the first process P1, the second process P2 and the third process P3, a number of laminations of the annular plates 1 in the laminated body 12 is increased.

The laminated body 12 is disposed inside a cylindrical body 14 of the manufacturing apparatus 4. Since the support section 13 that supports the laminated body 12 is lowered according to an increase in thickness dimension of the laminated body 12, a position of an upper surface of the laminated body 12 does not change.

As shown in FIG. 3C, when the lamination number of the laminated body 12 reaches a predetermined number (for example, 100), the adhesive agent layer 9 is not formed on the next annular plate 1 (1B). For this reason, the annular plate 1 (1B) on which the adhesive agent layer 9 is not formed is placed on the laminated body 12 (a completed laminated body 12A) having a predetermined number of laminations of annular plates 1. The annular plate 1 (1B) becomes a first plate of the next laminated body 12. Further, by repeating the first process P1, the second process P2 and the third process P3, a number of laminations of a new laminated body 12 is increased.

As the lamination number of the laminated body 12 is increased, the completed laminated body 12A gradually moves downward in the cylindrical body 14. As shown in FIG. 3D, the completed laminated body 12A that exits the cylindrical body 14 is extracted.

As shown in FIG. 3A to FIG. 3D, as the adhesive agent layer 9 is hardened in a process in which the laminated body 12 is moved downward, the annular plates 1 are adhered and fixed to each other via the adhesive agent layer 9.

In a process in which the laminated body 12 moves downward while hardening of the adhesive agent layer 9 proceeds, since a position of the laminated body 12 in the circumferential direction is shifted as each annular plates 1 are laminated, a shearing force in the circumferential direction is applied to the adhesive agent layer 9 of the laminated body 12.

In the manufacturing method of the embodiment, in the second process P2, when the annular plates 1 and the laminated body 12 are adhered by the adhesive agent 8 in the third process P3, since the adhesive agent 8 is applied such that the adhesive agent 8 becomes to a shape that is continuous in the circumferential direction about the central axis C1, the adhesive agent 8 is applied in a wide range about the axis. For this reason, a stress concentration does not easily occur even when a shearing force is applied to the adhesive agent layer in a hardening process, and inhibition of a hardening reaction due to a shearing stress does not easily occur. Accordingly, an adhesive strength of the adhesive agent layer 9 can be increased, and an amount of the adhesive agent 8 used can be minimized. Accordingly, a time required for hardening can be reduced, a speed of production can be increased, and minimization of manufacturing costs can be achieved.

In the manufacturing method of the embodiment, since the annular plates 1 are adhered and fixed via the adhesive agent layer 9, conduction between the annular plates 1 does not occur, and an increase in loss can be avoided. Further, since the process can be simplified, a decrease in productivity does not occur.

In the manufacturing method of the embodiment, as shown in FIG. 2A, since the adhesive agent 8 is applied on the surface 1a of the annular plate 1 in the plurality of spot shapes in the second process P2, as shown in FIG. 2B, when the annular plates 1 and the laminated body 12 are overlapped with each other in the third process P3, the adhesive agent 8 applied in the spot shapes are spread out and are securely applied on the surface la of the annular plates 1 in an annular shape. Accordingly, since the adhesive agent 8 is applied in a wide range about the central axis C1, the above-mentioned stress concentration will be further unlikely to occur.

In addition, since all the annular plates 1 on which the adhesive agent 8 is applied in the second process P2 are provided in the third process P3, a deviation of the lamination thickness in the circumferential direction of the annular plates 1 in the completed laminated body 12A does not easily occur.

In addition, flatness of the completed laminated body 12A becomes good. Accordingly, dimensional accuracy of the completed laminated body 12A can be improved.

In the manufacturing method of the embodiment, since the first process P1, the second process P2 and the third process P3 are performed in a common manufacturing apparatus 4, productivity can be increased in comparison with a manufacturing method in which an operation of extracting the steel plates from the manufacturing apparatus and a process of laminating the steel plates is needed.

According to the manufacturing apparatus 4, the lamination part 16 is configured to laminate the annular plates 1 while shifting positions of the annular plates 1 with respect to the laminated body 12 about the central axis C1 is provided. Here, since the adhesive agent 8 is applied on the surface 1a of the annular plate 1 in a plurality of spot shapes in the second process P2, when the annular plates 1 and the laminated body 12 are overlapped with each other in the third process P3, the adhesive agent 8 applied in the spot shapes are spread out, and the adhesive agent 8 is securely applied on the surface of the steel plate in an annular shape. For this reason, a stress concentration does not easily occur even when a shearing force is applied to the adhesive agent layer 9 in the hardening process, and inhibition of a hardening reaction due to a shearing stress does not easily occur. Accordingly, the stator core 10 in which the annular plates 1 are strongly adhered and fixed to each other is obtained.

Since an amount of the adhesive agent 8 used can be minimized without decreasing the adhesive strength of the adhesive agent layer 9, a time required for hardening can be reduced, a speed of production can be increased, and minimization of manufacturing costs can be achieved. In addition, since the annular plates 1 are adhered and fixed via the adhesive agent layer 9, conduction between the annular plates 1 does not occur, and an increase in loss can be avoided. Further, since the process is simplified, a decrease in productivity does not occur.

According to the manufacturing apparatus 4, the supply part 15 configured to apply the adhesive agent 8 on the surface 1a of the annular plate 1 in the plurality of spot shapes is provided such that the adhesive agent 8 is formed in a shape that is continuous in the circumferential direction about the central axis C1 when the annular plates 1 and the laminated body 12 are adhered to each other is provided. Since the adhesive agent 8 (the adhesive agent layer 9) is formed in a shape that is continuous in the circumferential direction, a stress concentration does not easily occur even when a shearing force is applied to the adhesive agent layer 9 in the hardening process. For this reason, inhibition of a hardening reaction due to a shearing stress does not easily occur. Accordingly, since the hardening reaction in the adhesive agent layer 9 proceeds normally and an adhesive strength of the adhesive agent layer 9 is increased, the stator core 10 in which the annular plates 1 are strongly adhered and fixed to each other is obtained. For this reason, an amount of the adhesive agent 8 used can be minimized without decreasing the adhesive strength of the adhesive agent layer 9. Accordingly, a time for required for hardening can be reduced, a speed of production can be increased, and minimization of manufacturing costs can be achieved.

According to the manufacturing apparatus 4, since the annular plates 1 are adhered and fixed via the adhesive agent layer 9, an increase in loss can be avoided without causing conduction between the annular plates 1. Further, since the process is simplified, a decrease in productivity does not occur.

### Example 1

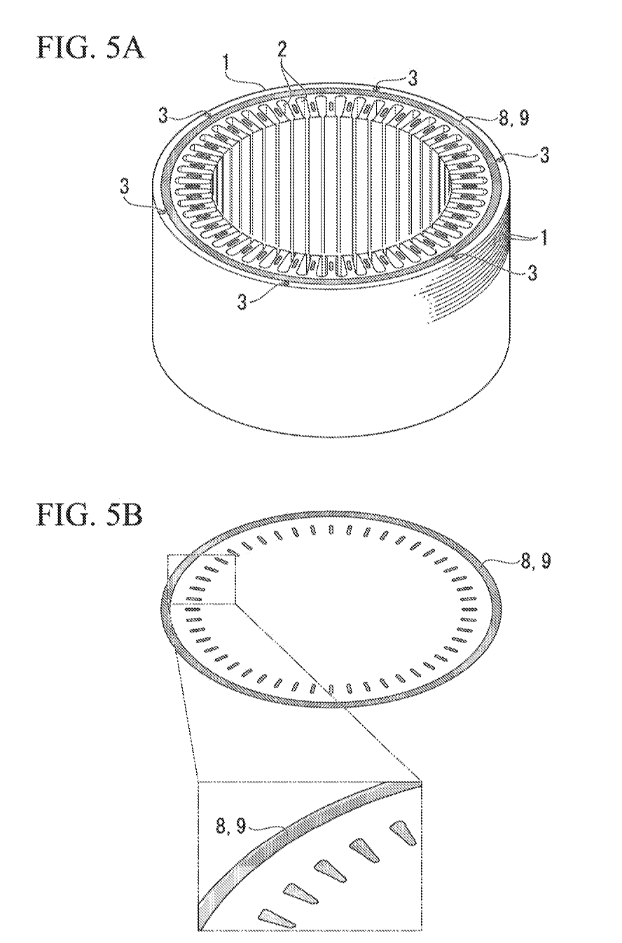

FIG. 5A is a perspective view showing a structure of a laminated body obtained by a manufacturing method of Example 1. FIG. 5B is a perspective view schematically showing an adhesive agent layer. Further, in FIG. 5A, the adhesive agent 8 applied in the spot shapes in the second process P2 is spread out in the third process P3 (see FIG. 2A), and a state in which the adhesive agent 8 is in a shape that is continuous in the circumferential direction about the central axis C1 is shown.

As shown in FIG. 1, a steel plate member was introduced into the manufacturing apparatus 4, and the annular plates 1 were obtained through punching (the first process P1).

As shown in FIG. 2A, the adhesive agent 8 that is an acrylic anaerobic adhesive agent (normal temperature hardenability) was applied at two places disposed at positions corresponding to the teeth 17 and one place between the neighboring teeth 17 in spot shapes at equal intervals about the central axis C1 (the second process P2).

As shown in FIG. 3A to FIG. 3D, the annular plates 1 were laminated while rotating the laminated body 12 about the central axis C1 by 60° (the third process P3). In the third process P3, positions of all the annular plates 1 that constitute the completed laminated body 12A in the circumferential direction were shifted with respect to the neighboring annular plates 1 by 60°. Here, the adhesive agent 8 applied in a spot shape is spread out when the annular plates 1 and the laminated body 12 are superimposed and adhered to each other. Accordingly, the adhesive agent layer 9 is formed in a shape that is continuous in the circumferential direction about the central axis C1 (see FIG. 5A and FIG. 5B).

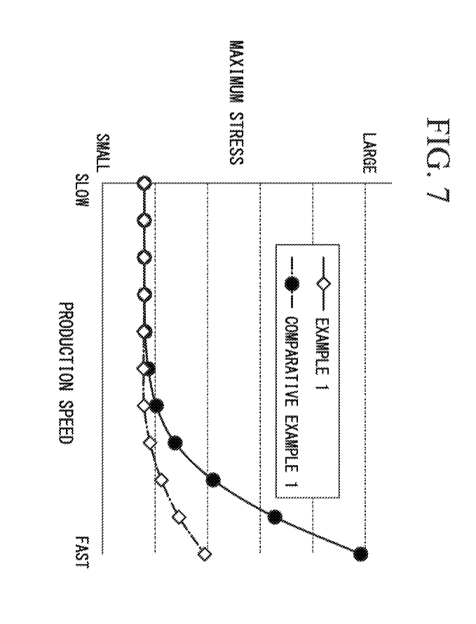

Stress occurring in the adhesive agent layer 9 when the laminated body 12 was rotated by 60° was calculated using a model. The results are shown in FIG. 5B and FIG. 7. In FIG. 5B, stress occurring in the adhesive agent layer 9 is shown by gradations of color. Stress is larger as a displayed color is darker. In FIG. 7, a vertical axis shows a maximum stress, and a lateral axis shows a speed of production (the number of annular plates 1 punched per a unit time).

As shown in FIG. 5B and FIG. 7, a maximum stress occurred in the adhesive agent layer 9 was reduced.

### Comparative Example 1

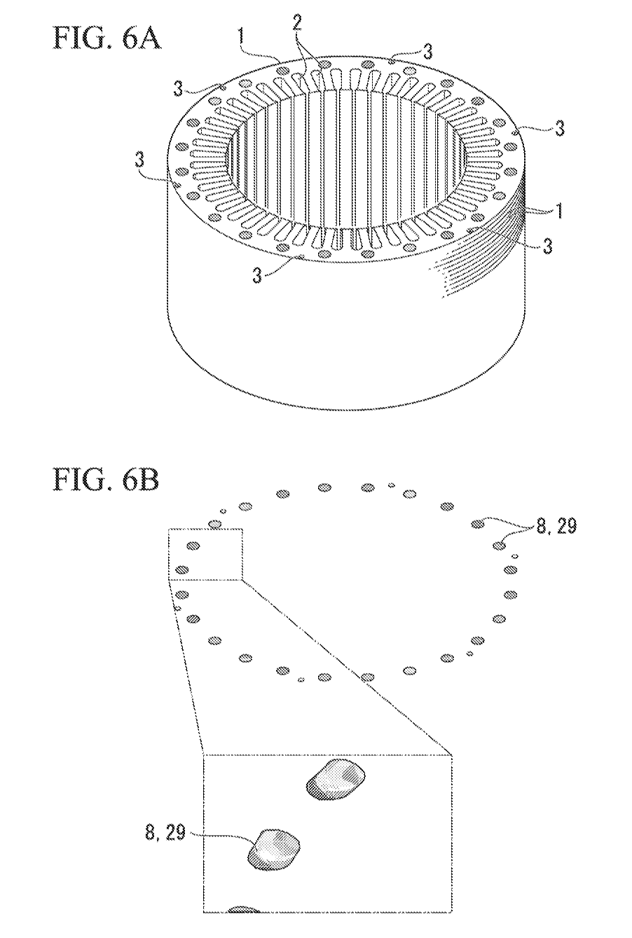

FIG. 6A is a perspective view showing a structure of a laminated body obtained by a manufacturing method of Comparative example 1. FIG. 6B is a perspective view schematically showing an adhesive agent layer. Further, FIG. 6A and FIG. 6B show a state in which, while the adhesive agent 8 applied in spot shapes are spread out, the spot shapes are separated from each other with no connection between the spot shapes in the circumferential direction about the central axis C1.

As shown in FIG. 6A, with respect to the teeth 17 aligned in the circumferential direction, an adhesive agent layer 29 was formed like in Example 1 except that the adhesive agent 8 was applied to positions corresponding to every other teeth 17 in the circumferential direction, respectively, in a total of 24 dot shapes. In Comparative example 1, when the annular plates 1 and the laminated body 12 are overlapped with each other in the third process P3, while the adhesive agent 8 applied in the dot shapes are spread out, the dot shapes are separated from each other without being connected between the neighboring dot shapes in the circumferential direction about the central axis C1 (see FIG. 6A and FIG. 6B). An area (an application area) of the adhesive agent layer 29 is the same as that of the adhesive agent layer 9 of Example 1, and the other conditions are the same as in Example 1.

Like Example 1, stress occurring in the adhesive agent layer 29 when the laminated body 12 is rotated was calculated using a model. The result is shown in FIG. 6B and FIG. 7.

As shown in FIG. 6B and FIG. 7, a maximum stress occurring in the adhesive agent layer 29 is larger than that in Example 1.

In addition, there were places where the stress become high (a place with a dark color) in all the adhesive agent layers 29 in the plurality of dot shapes. In comparison with Example 1 having a shape that is continuous in the circumferential direction about the central axis C1, the number of the adhesive agent layers 29 of Comparative example 1 is larger. For this reason, a total stress occurring in Comparative example 1 was larger than that in Example 1.

Further, the present invention is not limited to the above-mentioned embodiment and various design changes may be made without departing from the scope of the present invention.

For example, in the manufacturing method of the above-mentioned embodiment, in all the annular plates 1 passed through the second process P2, while positions of the annular plates 1 and the laminated body 12 in the circumferential direction are shifted with each other, there is no limitation thereto, and a method of shifting positions of the annular plates 1 and the laminated body 12 (so-called block rotating-buildup) in the circumferential direction at only some of the annular plates 1 passed through the second process P2 can also be adopted. For example, in the annular plates 1 that has passed through the second process P2, positions of the annular plates 1 and the laminated body 12 in the circumferential direction can be shifted with each other at every several plates among the plurality of annular plates.

In the manufacturing method of the first embodiment, while the adhesive agent layer that is continuous in the circumferential direction is formed on the surface of the steel plate, the number of adhesive agent layers is not limited to one, and for example, a second adhesive agent layer having a shape that is continuous in the circumferential direction may be formed at a position different from that of the adhesive agent layer in the radial direction. The second adhesive agent layer may have an annular shape (see FIG. 2A and FIG. 2B) or may have a plurality of arc shapes.

In the manufacturing method of the first embodiment, while all the steel plates are adhered and fixed by an adhesive agent, there is no limitation thereto and some of the plurality of steel plates that constitute the laminated steel plate may be fixed to another steel plate through another method (for example, welding) other than using an adhesive agent.

The laminated steel plate obtained by the manufacturing method of the embodiment is not limited to a stator core and, for example, may be appropriate for a rotor.

In the manufacturing method of the embodiment, while an object obtained by laminating the annular plates 1 (1A) in the third process P3 is the laminated body 12 constituted by a plurality of annular plates 1, the annular plate 1 (1A) may be laminated on one annular plate 1.

What is claimed is:

1. A method of manufacturing laminated steel plates by laminating a plurality of steel plates, the method comprising:
an application process of applying an adhesive agent on a surface of each of the steel plates; and
a lamination process of laminating a steel plate, on which the adhesive agent is applied, and another steel plate while shifting positions of the steel plates about an axis, which extends in a thickness direction of the steel plate, with each other, and causing the steel plate, to which the adhesive agent is applied, to adhere to the other steel plate by using the adhesive agent,
wherein, in the application process, the adhesive agent is applied such that the adhesive agent becomes in a shape that is continuous about the axis when the steel plate and the other steel plate are adhered by the adhesive agent in the lamination process.

2. The method of manufacturing the laminated steel plates according to claim 1, wherein, in the application process, the adhesive agent is applied on the surface of the steel plate in a plurality of spot shapes.

3. The method of manufacturing the laminated steel plates according to claim 1, wherein all the steel plates on which the adhesive agent is applied in the application process are supplied to the lamination process.

4. The method of manufacturing the laminated steel plates according to claim 1, wherein the application process and the lamination process are performed in a common manufacturing apparatus.

5. An apparatus for manufacturing laminated steel plates by laminating a plurality of steel plates, the apparatus comprising:
a supply part that applies an adhesive agent on a surface of each of the steel plates; and
a lamination part that laminates a steel plate, on which the adhesive agent is applied, and another steel plate while shifting positions of the steel plates about an axis, which extends in a thickness direction of the steel plate, with each other, and that causes the steel plate, to which the adhesive agent is applied, to adhere to the other steel plate by using the adhesive agent,
wherein the supply part applies the adhesive agent such that the adhesive agent becomes in a shape that is continuous about the axis when the steel plate and the other steel plate are adhered by the adhesive agent by the lamination part.
